(19) United States
(12) Patent Application Publication
(10) Pub. No.: US 2012/0323616 A1
(43) Pub. Date: Dec. 20, 2012

(54) METHODS AND SYSTEMS FOR DETERMINING DOWNTIME DRIVERS

(75) Inventors: David Richard SCHRICKER, Chillicothe, IL (US); Sean Martin Gladieux, Washington, IL (US); Andres Alberto Pabon, Peoria, IL (US); Douglas Charles Schroeder, East Peoria, IL (US); Dale Edward Milton, Brimfield, IL (US)

(73) Assignee: Caterpillar Inc.

(21) Appl. No.: 13/160,997

(22) Filed: Jun. 15, 2011

(51) Int. Cl. G06Q 10/00

(52) U.S. Cl. 705/7.11

(57) ABSTRACT

A downtime driver determining apparatus is disclosed. The apparatus may have a data collection module configured to collect machine downtime data and work order data from one or more databases, and a downtime identification module configured to identify a period of machine downtime from the machine downtime data. The apparatus may also have a downtime driver identification module configured to identify at least one work order from the work order data for the machine that was completed during the period of machine downtime, the at least one work order identifying at least one component of the machine, and a downtime attribution module configured to attribute at least part of the period of machine downtime to the at least one component of the machine included in the work order.

### TECHNICAL FIELD

The present disclosure is directed to a machine downtime determination system and, more particularly, to a system for determining drivers of machine downtime.

### BACKGROUND

Mining, construction, and other large scale operations require fleets of digging, loading, and hauling machines to remove and transport material such as ore or overburden from an excavation area to a predetermined destination. For such an operation to be profitable, the machines must achieve a high rate of availability (i.e. the machines must be operable a high percentage of the time). Thus, detecting times of machine unavailability (i.e. machine downtime) and the causes of the unavailability (i.e. downtime drivers) may be useful to ensure that the high rate of availability is achieved.

U.S. Patent Publication No. 2002/0107624 (the '624 publication) by Rutz published on Aug. 8, 2002 is directed to monitoring equipment for an agricultural machine. The '624 publication discloses a process computer that is connected to at least one sensor measuring an operational characteristic of the agricultural machine. If the process computer detects a fault in machine operation, it submits a fault message to a remote station using a communications interface. The fault message contains information identifying the type of the fault (e.g. engine problems, problems with towing or loading equipment, etc.). The '624 publication discloses that such fault messages make it possible to rectify the fault during operation, such as by sending a vehicle with spare parts to the location of the faulty machine.

While the system in the '624 publication may help to identify faults or errors in the operation of a machine, the system does not determine specific components (e.g., parts, part groups, and/or sub-systems) of the machine that caused the errors. Moreover, while the '624 publication may help to identify errors for a particular machine, it does not determine which components of the machine are driving downtime for an entire fleet of such machines or to what degree each component is driving downtime. In other words, it does not identify downtime drivers.

The disclosed system is directed to overcoming one or more of the problems as set forth above as well as other problems of the prior art.

### SUMMARY

In one aspect, the present disclosure is directed to a method for determining downtime drivers. The method may include collecting machine downtime data and work order data, storing the machine downtime data and work order data in one or more databases, and identifying a period of machine downtime from the machine downtime data. The method may also include identifying at least one work order from the work order data for the machine that was completed during the period of machine downtime, the at least one work order identifying at least one component of the machine, and attributing at least part of the period of machine downtime to the at least one component of the machine included in the work order.

In another aspect, the present disclosure is directed to an apparatus for determining downtime drivers. The apparatus may have a data collection module configured to collect machine downtime data and work order data from one or more databases, and a downtime identification module configured to identify a period of machine downtime from the machine downtime data. The apparatus may also have a downtime driver identification module configured to identify at least one work order from the work order data for the machine that was completed during the period of machine downtime and that identifies at least one component of the machine, and a downtime attribution module configured to attribute at least part of the period of machine downtime to the at least one component of the machine included in the work order.

In yet another aspect, the present disclosure is directed to a system for determining downtime drivers. The system may include one or more databases that store machine downtime data and work order data, and a computer including a processor and a memory storing instructions. The instructions, when executed by the processor, may enable the computer to collect machine downtime data and work order data and store the machine downtime data and work order data in one or more databases, and identify a period of machine downtime from the machine downtime data. The instructions may also enable the computer to identify at least one work order from the work order data for the machine that was completed during the period of machine downtime, the at least one work order identifying at least one component of the machine, and attribute at least part of the period of machine downtime to the at least one component of the machine included in the work order.

### BRIEF DESCRIPTION OF THE DRAWINGS

FIG. 1 is a diagrammatic illustration of an exemplary downtime driver determination system;

FIG. 2 is a diagrammatic illustration of an exemplary downtime driver determination apparatus that may be included in the system of FIG. 1;

FIG. 3 is a graph that may be generated by the system of FIG. 1 and/or the apparatus of FIG. 2;

FIG. 4 is a flow chart illustrating an exemplary disclosed method of operating the system of FIG. 1 and/or the apparatus of FIG. 2; and

FIG. 5 is a flow chart illustrating an exemplary disclosed method of operating the system of FIG. 1 and/or the apparatus of FIG. 2.

### DETAILED DESCRIPTION

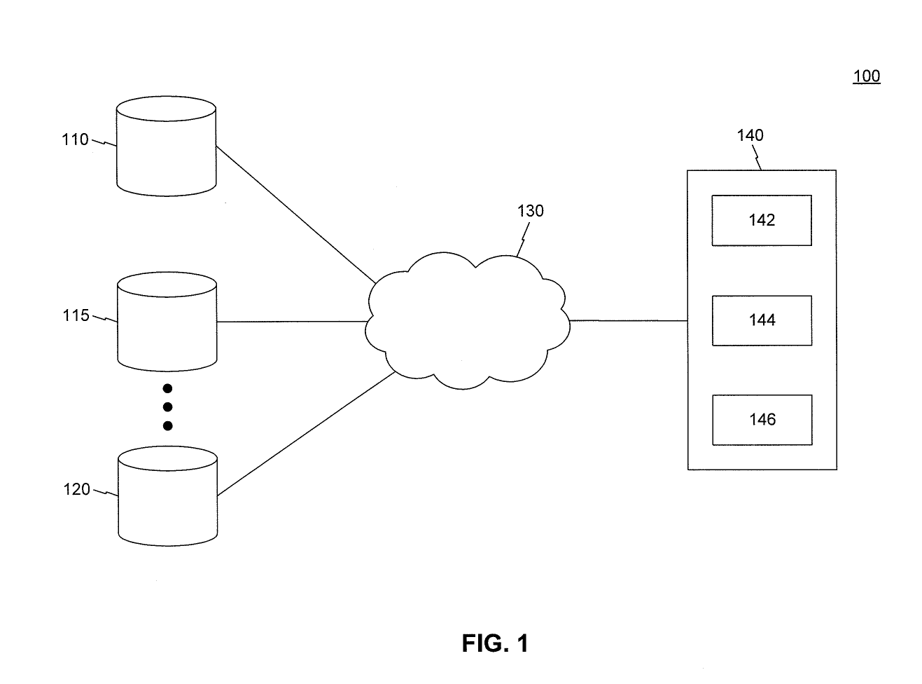

FIG. 1 illustrates an exemplary downtime driver determination system 100 that may be used to detect one or more causes of machine downtime for one or more machines in a fleet. Downtime driver detection system 100 may include one or more databases, such as a database 110, a database 115, and a database 120 connected via a network 130 to a computer 140. Computer 140 may query databases 110, 115, and/or 120 via network 130 to identify periods of machine downtime and determine which parts, part groups, and/or sub-systems (i.e. components) are responsible for the downtime (i.e. downtime drivers) for a particular machine or fleet of machines. Thus, computer 140 may function as a downtime driver determination apparatus. Computer 140 may include any number of computers. For example, in one embodiment, computer 140 may include multiple computers or computer servers configured to process data and determine downtime drivers in parallel, enabling computer 140 to efficiently process data related to multiple machines.

Computer 140 may include a processor 142, a memory 144, and a storage 146. Processor 142 may include one or more known processing devices, such as a microprocessor from the Pentium™ or Xeon™ family manufactured by Intel™, the Turion™ family manufactured by AMD™, any of various processors manufactured by Sun Microsystems, or any other type of processor. Memory 144 may include one or more storage devices configured to store information used by processor 142 to perform certain functions related to disclosed embodiments. Storage 146 may include a volatile or non-volatile, magnetic, semiconductor, tape, optical, removable, nonremovable, or other type of storage device or computer-readable medium. Storage 146 may store programs and/or other information, such as information that may be retrieved from databases 110, 115, and/or 120, as discussed in greater detail below.

In one embodiment, memory 144 may include one or more downtime driver determination programs or subprogram loaded from storage 146 or elsewhere that, when executed by computer 140, perform various procedures, operations, or processes consistent with disclosed embodiments. For example, memory 144 may include one or more programs that enable computer 140 to, among other things, collect machine downtime data and work order data, identify a period of machine downtime from the machine downtime data, identify at least one work order that was completed during the period of machine downtime, and attribute at least part of the period of machine downtime to a component of the machine that was included in the work order.

Databases 110, 115, and 120 may include one or more files or databases that store information and are accessed by computer 140. For example, in one embodiment, database 110 may include information related to machine downtime data, database 115 may include information related to work orders for machines, and database 120 may include linking data that links machine parts, part groups, sub-systems, and machines together. While three databases are shown in FIG. 1, any number of databases may be included in downtime driver determination system 100. Further, databases 110, 115, and 120 may be stored together in a single data repository or may be stored separately. In some embodiments, databases 110, 115, and 120 may be included in computer 140.

The information related to machine downtime data that may be stored in database 110, for example, may include any information related generally to machine availability and unavailability. For example, in certain embodiments, database 110 may include a list of downtime events (i.e. periods of time when a machine is not available) for one or more machines. The list of downtime events (e.g., machine downtime data) may include information such as the date, time, duration, location, reason, etc., for each of the downtime events. In certain embodiments, the list of downtime events may also identify one or more work orders that were performed during one or more downtime events, e.g., by a work order identifier. In other embodiments, database 110 may include a list of machine events and/or data that represent or correspond to machine availability. For example, if the machine is an off-highway or mining vehicle that loads and unloads payloads on a relatively consistent basis, then database 110 may include a list of payload events (i.e. times when the truck loads and/or unloads its payload), and their corresponding times. Computer 140 may identify a potential machine downtime by calculating the time between consecutive payload events and comparing the events to a predetermined threshold.

Database 110 may store machine events and machine data other than payload events as information related to machine downtime data. For example, database 110 may include data from sensors that determine whether a machine is operating, e.g. engine sensors, motor sensors, temperature sensors, sensors to determine axle rotation, or any other type of sensor that may indicate whether a machine is operating. The data from such sensors may be stored in database 110 as a time series of sensor values. Alternatively, the data may be stored as a time series of binary values, e.g., a “1” representing a measurement indicating that the machine is operating and a “0” representing a measurement indicating that the machine is not operating.

Further, the data stored in database 110 may be collected according to any method consistent with disclosed embodiments. In certain embodiments, downtime data may be entered directly, e.g., by a mechanic performing a repair, by an operator responsible for operating the machine, by a foreman, supervisor, or engineer, etc. For example, the mechanic may enter downtime data, e.g., date, time, duration, location, reason, etc., into a computer or workstation. In other embodiments, downtime data and/or information related thereto may be collected directly from the machine itself, e.g., via sensors that detect payload events and/or other machine events or data. For example, one or more sensors on the machine may send the data via a communication channel, e.g., a wireless network, in real-time or near-real-time to a base station where the data may be compiled and transferred to database 110. The one or more sensors may collect and store the data in one or more storage devices on the machine, and the data may then be transferred to the base station via any wired and/or wireless communication channel at certain times, e.g., shift changes, daily, weekly, etc.

The information related to work orders for machines that may be stored in database 115, for example, may include any information related generally to maintenance, repair, or other work performed on a machine. For example, database 115 may include work orders regarding repair events for a machine. Each work order may identify information regarding the repair event, e.g. date, time, duration, and location of the repair, the machine being repaired (e.g., the work order may include a machine identifier), the parts used (e.g., the work order may identify the parts used during the repair by including a list of part numbers), the machine sub-system being repaired (e.g., engine, turbocharger, motor, etc., which may be referred to by machine sub-system identifiers), etc. The work order may also include an identification of an estimated amount of labor time associated with the work order. The work order may also divide the labor time among different parts, part groups, and/or sub-systems included in the work order. For example, if a work order includes 6 hours of labor time, and identifies part numbers 1A1, 1B2, and 3C4, the work order may also include a division of the six hours of labor time among the three parts, e.g., 2 hours for part 1A1, 3 hours for part 1B2, and 1 hour for part 3C4.

The work order data may similarly be collected according to any method consistent with disclosed embodiments. In certain embodiments, the work order data may be entered directly, e.g., by a mechanic or engineer performing the tasks associated with the work order. For example, the mechanic may enter work order data, e.g., date, time, duration, location, reason, parts used, etc., into a computer or work station. In other embodiments, work order data may be collected automatically, e.g., using radio frequency identification (RFID) or any other method. For example, an RFID tag on a machine may indicate that the machine has stopped moving or has entered a service area. Further, RFID tags on parts being used during the task corresponding to the work order may similarly signal their location in proximity to the machine and thus indicate their use in the task. Software integrated with the RFID tags may then generate the work order data automatically.

The linking data that links machine parts, part groups, sub-systems, and machines together that may be stored in database 120, for example, may include any information that associates one or more parts, part groups, sub-systems, and/or machines with each other. Parts, part groups, sub-systems, and machines may be arranged in a hierarchical structure, so that each part group includes one or more parts, each sub-system includes one or more part groups, and each machine includes one or more sub-systems. Thus, database 120 may include schematic drawings, diagrams, charts, tables, etc., that relate one or more parts to one or more part groups, one or more part groups to one or more sub-systems, etc., and/or that define all or part of the hierarchical structure.

Network 130 may include any one of or combination of wired or wireless networks. For example, network 130 may include wired networks such as twisted pair wire, coaxial cable, optical fiber, and/or a digital network. Likewise, network 130 may include any wireless networks such as RFID, microwave or cellular networks or wireless networks employing, e.g., IEEE 802.11 or Bluetooth protocols. Additionally, network 130 may be integrated into any local area network, wide area network, campus area network, or the Internet.

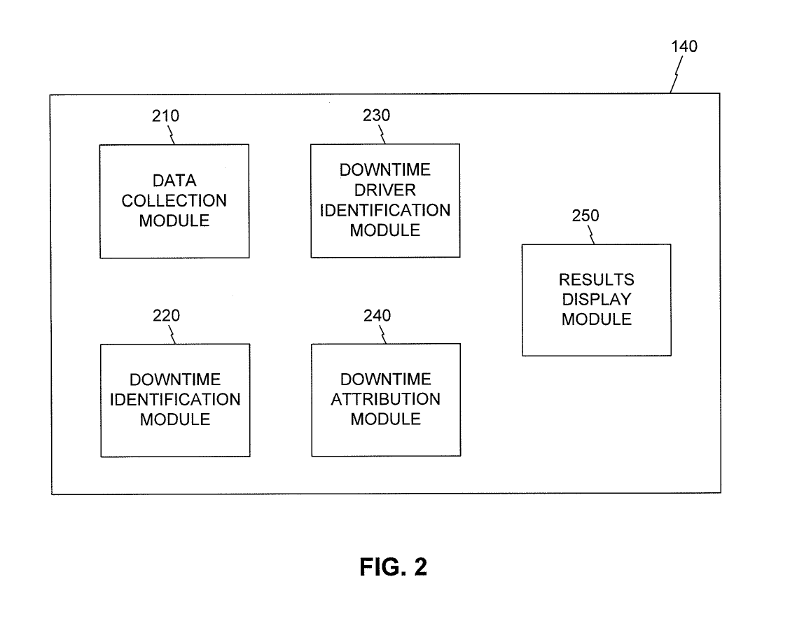

FIG. 2 shows an exemplary functional block diagram of computer 140, which may include a data collection module 210, a downtime identification module 220, a downtime driver identification module 230, a downtime attribution module 240, and a results display module 250. These modules may be implemented by any combination of hardware and/or software. For example, in some embodiments, one or more modules may be implemented in software stored in storage 146, which may be loaded into memory 144, and, when executed by processor 142, cause computer 140 to perform functions consistent with disclosed embodiments. Further, in some embodiments, one or more modules may include or use one or more input/output interfaces (not shown), e.g., to communicate with other modules or computers, to query databases 110, 115, 120, etc.

Data collection module 210 may be configured to collect machine downtime data, work order data, and/or linking data, such as databases 110, 115, and 120, and/or directly from one or more machines. Data collection module 210, through one or more input/output interfaces of computer 140, may query databases 110 and 115 in order to retrieve the machine downtime data and work order data. In some embodiments, data collection module 210, through one or more input/output interfaces of computer 140, may collect data measured by one or more sensors on one or more machines. Data collection module 210 may store the collected data in a storage device of computer 140, such as memory 144 and/or storage 146.

Downtime identification module 220 may be configured to identify a period of machine downtime from the machine downtime data collected by data collection module 210. In embodiments where the machine downtime data includes actual machine downtime instances, downtime identification module 220 may identify the periods of machine downtime from those instances. In embodiments, as discussed above, where the machine downtime data includes machine events or data, downtime identification module 220 may analyze the data to identify periods of machine downtimes. For example, in an embodiment where the machine downtime data includes a time series of payload events, downtime identification module 220 may determine the time between consecutive payload events and compare that time to a predetermined threshold. If the time exceeds the predetermined threshold, downtime identification module 220 may determine that the time between payload events is a period of machine downtime. In certain embodiments, if downtime identification module 220 determines that the time exceeds the predetermined threshold, downtime identification module 220 may compare that time to the work order data collected by data collection module 210 to determine whether a work order exists for that particular machine during that time. If such a work order exists, downtime identification module 220 may determine that the time between payload events is a period of machine downtime.

Downtime identification module 220 may determine the predetermined threshold based on an average work cycle of the machine. For example, in an embodiment where the machine downtime data includes a time series of payload events, downtime identification module 220 may determine that the average time between payload events is, e.g., 30 minutes. Thus, downtime identification module 220 may determine that the predetermined threshold is twice the average time between payload events, e.g., 60 minutes. Of course, any amount of time may be used as the predetermined threshold, e.g., two-and-a-half times the average time between payloads, three times the average time, etc. Moreover, other data may be used to determine the predetermined threshold, e.g., the median work cycle of the machine, a statistical analysis of the work cycle of the machine, a suggested time from an operator of the machine, an engineer, or a fleet supervisor, etc.

Downtime driver identification module 230 may be configured to identify at least one work order from the work order data for the machine that was completed during the period of machine downtime and may also be configured to identify at least one component (e.g. part, part group, sub-system, etc.) of the machine as a downtime driver. In embodiments where the machine downtime data includes work orders identified by work order identifiers, downtime driver identification module 230 may identify the work orders using the work order identifiers in the machine downtime data. In other embodiments, downtime driver identification module 230 may identify a work order that was completed during the period of machine downtime by cross-referencing the work order data collected by data collection module 210 with the period of machine downtime determined by downtime identification module 220.

If a work order was completed for a particular machine during the period of machine downtime for that machine, then downtime driver identification module 230 may identify one or more downtime drivers based on information in the work order. For example, in some embodiments, the work order data may identify parts, part groups, and/or sub-systems that were used and/or repaired in the work order. In certain embodiments, the work order data may only identify the parts used, and may not identify the part groups and/or sub-systems. In other embodiments, the work order may include such data, but it may not be reliable, because the mechanic or engineer performing the tasks may not know the part group numbers or sub-system numbers, or may enter the numbers incorrectly.

In certain embodiments, downtime driver identification module 230 may be configured to identify the group numbers and/or sub-systems as downtime drivers based on the part numbers identified in the work order and the linking data collected by data collection module 210 that links machine parts, part groups, sub-systems, and machines. For example, a work order may identify five parts that were used during the repair or maintenance associated with the work order. The parts used each may be identified by a part number, such as, part number 1, 2, 3, 4, and 5, for simplicity. Thus, the work order may list part numbers 1-5 as being used in the work order. Downtime driver identification module 230 may use the part numbers and the linking data in order to match the part numbers to one or more part groups and/or sub-systems in order to determine which part groups and/or sub-systems were repaired during the work order.

For example, in certain embodiments, each part number may correspond to a particular part group. Thus, the data that links part numbers may link a particular part number to its part group. Similarly, each part group may correspond to a particular sub-system, and the data may similarly link groups and sub-systems. In other embodiments, parts, part groups, and sub-systems may not necessarily have a one-to-one correspondence. For example, in some embodiments, a part may be used in multiple part groups, and, thus, a particular part number may potentially correspond to multiple part group numbers.

In embodiments where part numbers may correspond to more than one part group number, downtime driver identification module 230 may identify part group numbers by determining which part group number is the most likely part group number. For example, if the work order includes part numbers 1-5, downtime driver identification module 230 may query the database that includes the linking data and retrieve the following information: part number 1 corresponds only to group A; part number 2 may correspond to groups A or B; part number 3 corresponds to group A; part number 4 corresponds to group C; and part number 5 corresponds to group D. Based on these results, downtime driver identification module 230 will determine that part groups A, C, and D were repaired during the work order.

Specifically, when part numbers in a work order may correspond to multiple part group numbers, downtime driver identification module 230 may first determine which part numbers only correspond to one part group number, and determine that those part groups were repaired during the work order and are thus downtime drivers. Next, downtime driver identification module 230 may identify the part numbers that may correspond to more than one part group number. If one of the part groups corresponding to the part has already been determined to be a downtime driver, then downtime driver identification module 230 may determine that the part corresponds to the part group that has already been identified as a downtime driver. In the example above, downtime driver identification module 230 may determine that part number 2 corresponds to part group A instead of part group B, because part group A has already been determined to be a downtime driver based on part numbers 1 and 3.

If a part number corresponds to multiple part group numbers that have been identified as a downtime driver, or if a part number corresponds to multiple part group numbers and none of them have been identified as downtime drivers, downtime driver identification module 230 may determine which part group number corresponds to the part number based on other methods, e.g., randomly, choosing the part group with the lowest (or highest) number, choosing the part group that is repaired most frequently, choosing the part group that is most similar to other previously identified downtime drivers, etc.

Sub-systems and part groups may be related in the same hierarchical manner as part groups and part numbers. Thus, the processes described above for identifying part groups as downtime drivers may be used to identify sub-systems as downtime drivers.

Downtime attribution module 240 may be configured to attribute at least part of the period of machine downtime to the downtime drivers that were identified by downtime driver identification module 230. In certain embodiments, the work order may identify the labor time associated with each part, e.g., the work order may include part number/labor time groupings. In these embodiments, downtime attribution module 240 may attribute time to each component based on the part number/labor time groupings. For example, if the components to which the time is being attributed are part groups, downtime attribution module 240 may attribute to each part group the sum of the labor time associated with all of the part numbers from the work order that correspond to the particular part group. As discussed above, downtime driver identification module 230 may determine which parts correspond to which part groups.

In other embodiments, downtime attribution module 240 may attribute the period of machine downtime to the identified downtime drivers by equally dividing the period of machine downtime across all identified downtime drivers. For example, if the period of machine downtime is three hours, and downtime driver identification module 230 identified three downtime drivers (part groups A, C, and D), downtime attribution module 240 may attribute one hour of machine downtime to each of the three downtime drivers.

If, as discussed above, downtime driver identification module 230 determines that multiple work orders correspond to a period of machine downtime, downtime attribution module 240 may attribute the period of machine downtime to components in each of the work orders based on the estimated labor time associated with each work order, in comparison to the other work orders. In one embodiment, downtime attribution module 240 may attribute a pro rata part of the period of machine downtime to the components of each work order.

For example, the total period of machine downtime may have been three hours. Two work orders, work order 1 and work order 2, may have been completed during the period. Work order 1 may have an estimated labor time of two hours and work order 2 may have an estimated labor time of four hours. In this case, downtime attribution module 240 may attribute one hour of the machine downtime to work order 1 and two hours of the machine downtime to work order 2. Downtime attribution module 240 may then attribute the machine downtime to the components included in each of the work orders, as discussed above.

In some embodiments, downtime attribution module 240 may be configured to analyze an entire fleet of machines, to attribute downtime to components for each of the machines in the fleets, and calculate a total downtime attributed to each of the components.

Results display module 250 may be configured to generate and output a list of components to which have been attributed the most total downtime. For example, results display module 250 may obtain data from downtime attribution module 240 that may indicate how much downtime has been associated with each component. Results display module 250 may then sort the components in order of descending attributed downtime, and may display the list to a user, e.g., at computer 140 or elsewhere. In some embodiments, results display module 250 may display a graph for the top downtime drivers. Results display module 250 may display results for components at any level of the hierarchy, e.g., parts, part groups, sub-systems, etc.

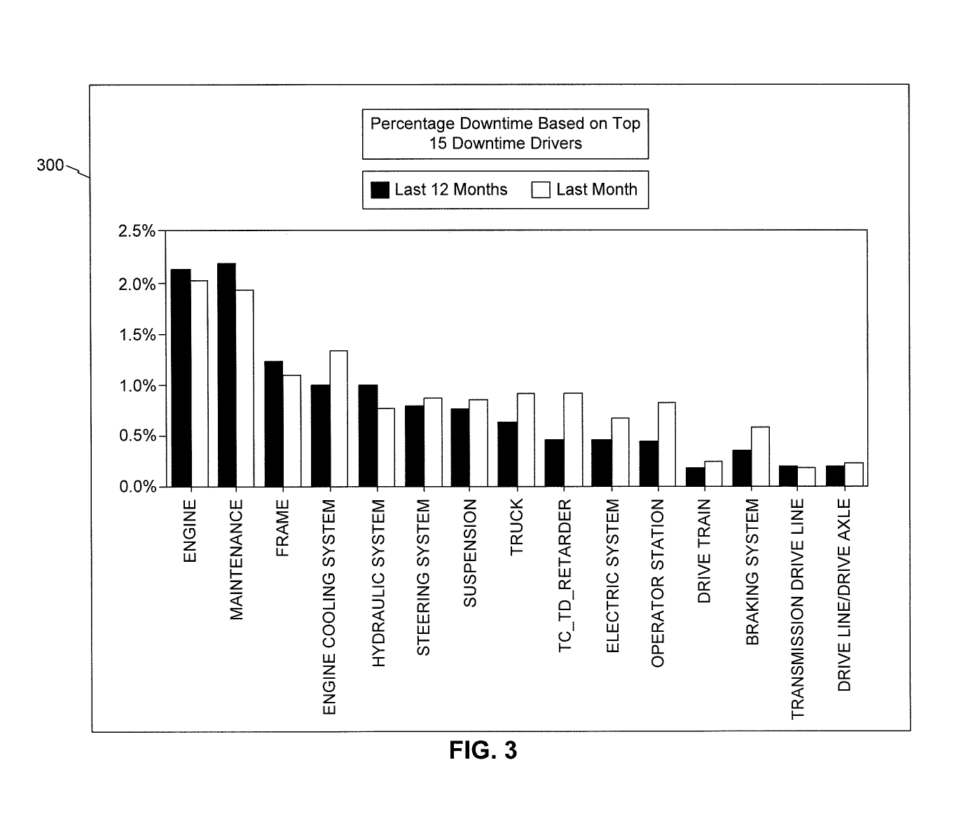

FIG. 3 shows an exemplary graph 300 that may be generated and displayed by results display module 250. For example, graph 300 includes the fifteen sub-systems of a machine to which are attributed the most downtime. Graph 300 also includes a representation of the percentage of total downtime that each of the sub-systems caused over both the last month and the last year. Graph 300 is merely for illustrative purposes. Results display module 250 may be configured to display any other type of chart, list, or graph to display the data analyzed and/or generated by computer 140.

### INDUSTRIAL APPLICABILITY

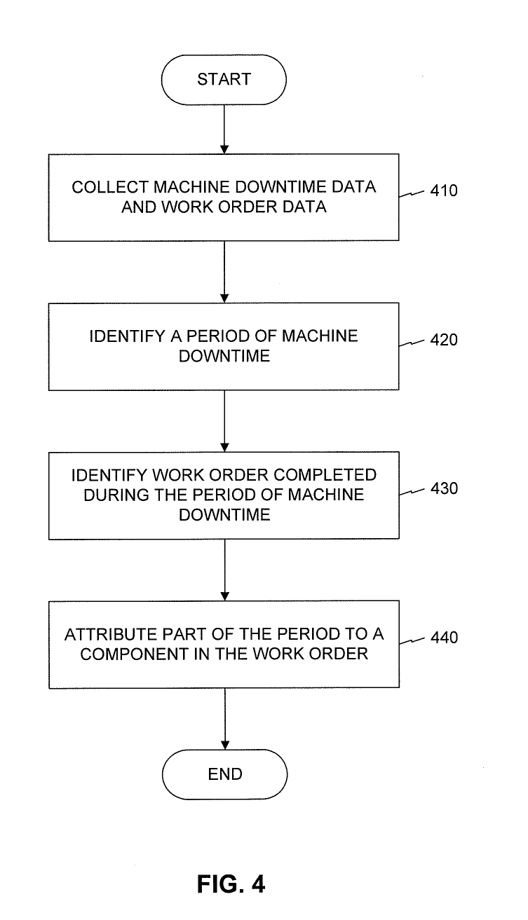

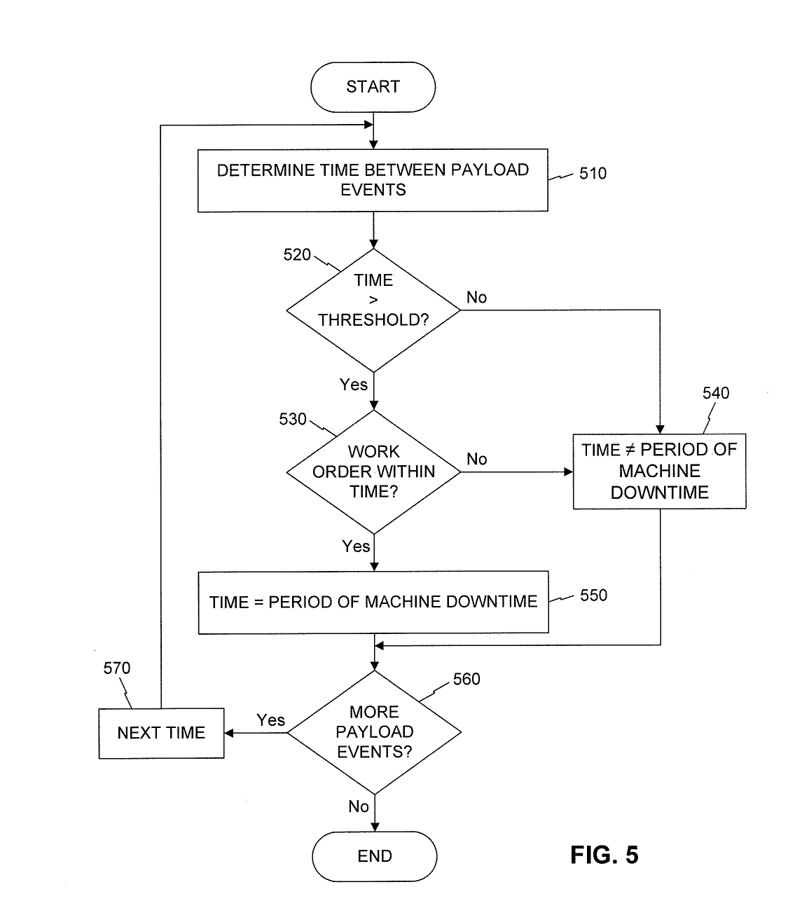

The disclosed downtime driver determination system 100 may be applicable for determining downtime drivers for any machine or fleet of machines. In particular, downtime driver determination system 100 may be used to identify periods of machine downtime for a fleet of machines, and determine which components of the machines have caused the downtime. Detection of such downtime drivers may allow for effective maintenance and efficient repair, resulting is less downtime for machines in the fleet. The operation of downtime driver determination system 100 will now be explained in connection with the flowcharts of FIGS. 4 and 5.

During operation of downtime driver determination system 100, computer 140 may collect machine downtime data and work order data (step 410). For example, computer 140 may query databases, such as databases 110, 115, and/or 120, which may store previously collected machine downtime data. This data may have been collected from various sensors and/or operator inputs, as discussed above. Additionally, computer 140 may communicate with sensors and/or devices that receive operator inputs in order to collect the data.

After collecting the machine downtime data and work order data, computer 140 may identify a period of machine downtime (step 420). In some embodiments, the machine downtime data may indicate periods of machine downtime. In other embodiments, the machine downtime data may include information regarding work cycles of the different machines, and computer 140 may identify periods of machine downtime by analyzing the work cycle information. In one embodiment, computer 140 may identify periods of machine downtime by comparing the machine downtime data and the work order data, as described in greater detail below with regard to FIG. 5.

After identifying a period of machine downtime, computer 140 may identify a work order completed during the period of machine downtime (step 430). For example, computer 140 may analyze the work order data collected in step 410 to determine if any of the work orders have been completed during the period of machine downtime identified in step 420. In some embodiments, if multiple work orders have been completed during the period of machine downtime, computer 140 may identify all of the work orders that were completed. Computer 140 may then attribute at least part of the period of machine downtime to a component that is included in the identified work order (step 440).

As discussed above, at step 430, computer 140 may determine that multiple work orders correspond to a period of machine downtime. In this case, at step 440, computer 140 may attribute the period of machine downtime to components in each of the work orders based on the estimated labor time associated with each work order, in comparison to the other work orders. In one embodiment, computer 140 may attribute a pro rata part of the period of machine downtime to the components of each work order.

When attributing the period of machine downtime to one or more components, computer 140 may analyze data in any of the ways discussed above. For example, if the work order data identifies part numbers, computer 140 may attribute the period of machine downtime to part groups and/or sub-systems based on work order data and linking data. Similarly, if multiple work orders were identified in step 430, computer 140 may attribute the period of machine downtime to components in the work orders in pro rata amounts based on the estimated labor time for each work order.

As discussed above, in some embodiments, computer 140 may identify periods of machine downtime by comparing the machine downtime data and the work order data. FIG. 5 is a flowchart of an exemplary method that computer 140 may implement in order to identify the periods of machine downtime.

In one embodiment, the machine downtime data may include payload data that identifies a time series of payload events (e.g., when a machine, such as an off-highway vehicle loads or unloads a payload). Computer 140 may analyze the machine downtime data to determine the amount of time between two payload events (step 510). For example, computer 140 may determine the time between two consecutive payload events. Computer 140 may also determine whether the time between payload events is greater than a predetermined threshold (step 520). The threshold may be determined based on, e.g., work cycle data of the machine, such as the average work cycle, median work cycle, etc. If the time between payload events is not greater than the predetermined threshold, computer 140 may determine that the time between payload events is not a period of machine downtime (step 540). On the other hand, if the time between payload events is greater than the predetermined threshold, computer 140 may compare the machine downtime data to the work order data to determine whether a work order was completed within the period of machine downtime (step 530).

If computer 140 determines that no work order was completed within the period of machine downtime, computer 140 may determine that the time between payload events is not a period of machine downtime (step 540). On the other hand, computer 140 determines that a work order was completed within the period of machine downtime, computer 140 may designate the time between payload events as a period of machine downtime (step 550). Thus, in some embodiments, computer 140 may analyze the period of machine downtime to determine one or more downtime drivers and attribute at least part of the machine downtime to the downtime drivers, as discussed above with regard to steps 430 and 440.

Computer 140 may determine whether additional machine downtime data exists (step 560). For example, if the machine downtime data is a time series of payload events, computer 140 may determine whether additional payload events exist in the time series. If additional payload events do not exist, computer 140 may stop analyzing the machine downtime data. On the other hand, if additional payload events do exist, computer 140 may move to the next time between two payload events (step 570) and repeat the process for the next time.

It will be apparent to those skilled in the art that various modifications and variations can be made to the disclosed downtime driver determination system. Other embodiments will be apparent to those skilled in the art from consideration of the specification and practice of the disclosed downtime driver determination system. It is intended that the specification and examples be considered as exemplary only, with a true scope being indicated by the following claims and their equivalents.

What is claimed is:

1. A computer-implemented method for determining downtime drivers for a machine comprising:
collecting machine downtime data and work order data and storing the machine downtime data and work order data in one or more databases;
identifying a period of machine downtime from the machine downtime data;
identifying at least one work order from the work order data for the machine that was completed during the period of machine downtime, the at least one work order including at least one component of the machine; and
attributing at least part of the period of machine downtime to the at least one component of the machine included in the work order.

2. The computer-implemented method of claim 1, wherein:
the machine downtime data is payload data including a series of payload events; and
identifying the period of machine downtime includes:
identifying a time period between the payload events that exceeds a predetermined threshold time; and
designating the time period between payload events as the period of machine downtime if a work order exists for the machine in the time period between payload events.

3. The computer-implemented method of claim 2, further including determining the predetermined threshold time based on an average work cycle of the machine.

4. The computer-implemented method of claim 1, wherein:
a plurality of work orders are completed during the period of machine downtime, each of the work orders including an estimated labor time; and
attributing the period of machine downtime includes attributing a pro rata part of the period of machine downtime to each of the work orders based on the estimated labor time of each work order.

5. The computer-implemented method of claim 1, wherein the at least one component of the machine includes a plurality of parts of a machine, each of the plurality of parts identified in the work order by a part number, and the computer-implemented method further includes:
matching each of the plurality of part numbers to one or more part groups of the machine; and
attributing at least part of the period of machine downtime to each of the one or more part groups based on the matching.

6. The computer-implemented method of claim 5, wherein each of the plurality of part numbers is matched to a part group of the one or more part groups based on a query to a database that links part numbers to part groups.

7. The computer-implemented method of claim 1, further including:
attributing periods of machine downtime to components of a plurality of machines;
calculating a total downtime attributed to each of the components; and
outputting a list of components together with the total downtime attributed to each of the components.

8. A device for determining downtime drivers for a machine comprising:
a data collection module configured to collect machine downtime data and work order data from one or more databases;
a downtime identification module configured to identify a period of machine downtime from the machine downtime data;
a downtime driver identification module configured to identify at least one work order from the work order data for the machine that was completed during the period of machine downtime, the at least one work order including at least one component of the machine; and
a downtime attribution module configured to attribute at least part of the period of machine downtime to the at least one component of the machine included in the work order.

9. The device according to claim 8, wherein:
the data collection module is further configured to collect payload data including a series of payload events as the machine downtime data; and
the downtime driver identification module is further configured to:
identify a time period between the payload events that exceeds a predetermined threshold time; and
designate the time period between payload events as the period of machine downtime if a work order exists for the machine in the time period between payload events.

10. The device of claim 8, wherein:
a plurality of work orders are completed during the period of machine downtime, each of the work orders including an estimated labor time; and
the downtime attribution module is further configured to attribute a pro rata part of the period of machine downtime to each of the work orders based on the estimated labor time of each work order.

11. The device of claim 8, wherein:
the at least one component of the machine includes a plurality of parts of a machine, each of the plurality of parts identified in the work order by a part number; and
the downtime attribution module is further configured to:
match each of the plurality of part numbers to one or more part groups of the machine; and
attribute at least part of the period of machine downtime to each of the one or more part groups based on the match.

12. The device of claim 11, wherein the downtime attribution module is further configured to match each of the plurality of part numbers to the one or more part groups based on a query to a database that links part numbers to part groups.

13. The device of claim 8, wherein:
the downtime attribution module is further configured to:
attribute periods of machine downtime to components of a plurality of machines; and
calculate a total downtime attributed to each of the components; and
the apparatus further includes a results display module configured to output a list of components together with the total downtime attributed to each of the components.

14. A system for determining downtime drivers for a machine comprising:
one or more databases that store machine downtime data and work order data; and
a computer including a processor and a memory storing instructions that, when executed by the processor, enable the computer to:
collect machine downtime data and work order data from the one or more databases;
identify a period of machine downtime from the machine downtime data;
identify at least one work order from the work order data for the machine that was completed during the period of machine downtime, the at least one work order including at least one component of the machine; and
attribute at least part of the period of machine downtime to the at least one component of the machine included in the work order.

15. The system of claim 14, wherein:
the machine downtime data is payload data including a series of payload events; and
the instructions further enable the computer to:
identify a time period between the payload events that exceeds a predetermined threshold time; and
designate the time period between payload events as the period of machine downtime if a work order exists for the machine in the time period between payload events.

16. The system of claim 15, wherein the predetermined threshold time is based on an average work cycle of the machine.

17. The system of claim 14, wherein:
a plurality of work orders are completed during the period of machine downtime, each of the work orders including an estimated labor time; and
the instructions further enable the computer to attribute a pro rata part of the period of machine downtime to each of the work orders based on the estimated labor time of each work order.

18. The system of claim 14, wherein:
the at least one component of the machine includes a plurality of parts of a machine, each of the plurality of parts identified in the work order by a part number; and
the instructions further enable the computer to:
match each of the plurality of part numbers to one or more part groups of the machine; and
attribute at least part of the period of machine downtime to each of the one or more part groups based on the matching.

19. The system of claim 18, wherein the instructions further enable the computer to match each of the plurality of part numbers to the one or more part groups based on a query to a database that links part numbers to part groups.

20. The system of claim 14, wherein the instructions further enable the computer to:
attribute periods of machine downtime to components of a plurality of machines;
calculate a total downtime attributed to each of the components; and
output a list of components together with the total downtime attributed to each of the components.
